(19) United States
(12) Patent Application Publication
(10) Pub. No.: US 2022/0418072 A1
(43) Pub. Date: Dec. 29, 2022

(54) LIGHTING SYSTEM, POWER SUPPLY DEVICE, LIGHTING FIXTURE, MAPPING METHOD, AND PROGRAM

(71) Applicant: Panasonic Intellectual Property Management Co., Ltd., Osaka (JP)

(72) Inventors: Akihiro KISHIMOTO, Osaka (JP); Hajime OZAKI, Kyoto (JP); Tatsumi SETOMOTO, Osaka (JP); Shigeo NAKAMURA, Osaka (JP); Sana YAGI, Osaka (JP)

(21) Appl. No.: 17/772,743

(22) PCT Filed: Oct. 9, 2020
(86) PCT No.: PCT/JP2020/038246

§ 371 Date: Apr. 28, 2022

(30) Foreign Application Priority Data
Oct. 30, 2019 (JP) 2019-196896

(51) Int. Cl. H05B 47/16; H05B 47/19

(52) U.S. Cl. CPC H05B 47/16; H05B 47/19

(57) ABSTRACT

A lighting system includes a plurality of lighting fixtures and a terminal device—that controls the plurality of lighting fixtures, wherein: each of the plurality of lighting fixtures transmits, to the terminal device, identification information and acquired information; and the terminal device classifies the plurality of lighting fixtures—on the basis of the information acquired respectively by the plurality of lighting fixtures.

### TECHNICAL FIELD

The present disclosure relates to a lighting system, a power supply device, a lighting fixture, a mapping method, and a program.

### BACKGROUND

Immediately after mounting, at installation positions on a ceiling of a building, lighting fixtures that turn on and off by receiving a plurality of control signals, a relation between identification information of each of the lighting fixtures and position information indicating the position of the lighting fixture is not clear, and lighting of each of the lighting fixtures cannot be controlled. For this reason, mapping is carried out, which is a work of associating the identification information and the position information of a plurality of lighting fixtures using a terminal device.

Patent Document 1 discloses a lighting system comprising a plurality of lighting fixtures and a setting device for instructing a dimming degree of each of the plurality of lighting fixtures to enable dimming.

### CITATION LIST

### Patent Literature

PATENT DOCUMENT 1: JP 2016-103372 A

### SUMMARY

### Technical Problem

In a case where mapping is performed using a terminal device in a conventional lighting system, when an operator selects identification information of lighting fixtures displayed on a screen of a terminal device, since the lighting fixture corresponding to the selected identification information blinks, the operator goes near the blinking lighting fixture. Then, the operator confirms a position of the lighting fixture and touches a mark of the corresponding position in an arrangement plan of the lighting fixtures to perform an association between identification information and position information. At this time, since the number of installed lighting fixtures increases in one office with a large room area, it takes time for the operator to confirm the positions of the lighting fixtures. Further, in a case of acquiring identification information of the lighting fixtures using a wireless signal from the terminal device in a large-scale lighting system installed in a commercial facility such as a shopping mall having an open ceiling, identification information of the lighting fixtures installed in a different floor may also be often acquired by the terminal device, and it takes time to confirm whether mapping is required for the light fixtures on the present floor.

An advantage of the present disclosure is to provide a lighting system, a power supply device, a lighting fixture, a mapping method, and a program capable of shortening a work time when mapping of a plurality of lighting fixtures is performed using a terminal device.

### Solution to Problem

An aspect of the present disclosure provides a lighting system including a plurality of lighting fixtures and a terminal device that controls the plurality of lighting fixtures, wherein each of the plurality of lighting fixtures transmits identification information and acquired information to the terminal device, and the terminal device classifies the plurality of lighting fixtures based on the information acquired by each of the plurality of lighting fixtures.

An aspect of the present disclosure provides a power supply device incorporated in the lighting fixture of the lighting system according to the present disclosure, the power supply device including a power conversion unit, a control unit, a communication unit, a storage unit, and a measurement unit, and being configured to measure the information in the measurement unit based on a predetermined operation or a predetermined action and to store the information measured by the measurement unit in the storage unit when a predetermined detection is made.

An aspect of the present disclosure provides a lighting fixture including the power supply device according to the present disclosure.

An aspect of the present disclosure provides a mapping method of the lighting system according to the present disclosure by which the identification information of each of the plurality of lighting fixtures is associated with position information of the plurality of lighting fixtures, wherein each of the plurality of lighting fixtures transmits identification information and acquired information to the terminal device, the terminal device classifies and displays the identification information of the plurality of lighting fixtures based on the information acquired by each of the plurality of lighting fixtures, and a user operates the terminal device so as to associate the identification information of the lighting fixtures displayed on the terminal device with marks indicating installation positions of the lighting fixtures.

An aspect of the present disclosure provides a program capable of being read in the terminal device in the lighting system according to the present disclosure, the program causing the terminal device to execute classification of the plurality of lighting fixtures based on the information acquired by each of the plurality of lighting fixtures.

### Advantageous Effects of Invention

According to a lighting system, a power supply device, a lighting fixture, a mapping method, and a program which are aspects of the present disclosure, it is possible to shorten a work time when mapping of a plurality of lighting fixtures is performed using a terminal device.

### BRIEF DESCRIPTION OF DRAWINGS

FIG. 1 is a diagram showing an example of a lighting system according to an embodiment.

FIG. 2 is a view showing arrangement positions and wire-connection states of a plurality of lighting fixtures in a room in the lighting system according to the example of the embodiment.

FIG. 3 is a block diagram showing configurations of a lighting fixture and a terminal device shown in FIG. 1.

FIG. 4A is a flowchart showing a mapping method of the lighting system in the embodiment.

FIG. 4B is a view showing a screen immediately after the start of operation of a mapping program in an operation display unit of the terminal device in the embodiment.

FIG. 4C is a view showing a screen displayed by pressing an arrangement plan reading button in FIG. 4B.

FIG. 5A is a view showing an example of a relation between the energizing time and the number of the lighting fixtures acquired when energizing times of a plurality of switches are made different in the embodiment.

FIG. 5B is a view showing another example of a relation between the energizing time and the number of the lighting fixtures acquired when energizing times of a plurality of switches are made different in the embodiment.

FIG. 6 is a view showing identification information of the grouped lighting fixtures on the screen displayed by pressing the lighting fixture reading button in FIG. 4C and a corresponding relation between the energizing time and the number of the lighting fixtures.

FIG. 7 is a schematic view showing a state in which the terminal device receives information via a lighting control controller from a plurality of lighting fixtures divided on different floors in the embodiment.

FIG. 8 is a diagram showing a lighting system of another example of the embodiment.

FIG. 9 is a diagram showing an example of a relation between the number of power-on times of some of the lighting fixtures and the energizing time corresponding to the number of power-on times which are acquired in the lighting system of another example of the embodiment.

### DESCRIPTION OF EMBODIMENTS

An embodiment of a lighting system according to the present disclosure will be described in detail below with reference to the drawings. However, the present disclosure is not limited to the embodiment described below. In the following embodiment, the same components are designated by the same reference numerals in the drawings, and duplicated description will be omitted or simplified.

A main constituent of the system of the present disclosure includes a computer. When the computer executes a program, a function of the main constituent of the system of the present disclosure is realized. The computer includes a processor, which actuates according to the program, as a main hardware configuration. The processor may be of any type, so long as the function described above can be realized by executing the program. The processor is configured by one electronic circuit or a plurality of electronic circuits including an integrated circuit (IC) or a large scale integrated circuit (LSI). The plurality of electronic circuits may be integrated on one chip, or may be provided on a plurality of chips. The plurality of chips may be integrated into one device, or may be provided in a plurality of devices. Further, the program is stored in a non-temporary storage medium such as a computer-readable ROM, an optical disk, or a hard disk drive. The program may be stored in advance in the storage medium, or may be supplied to the storage medium via a wide area communication network including the Internet.

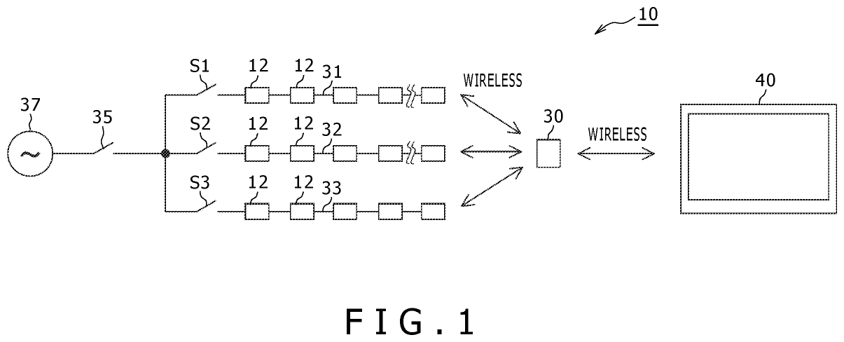

FIG. 1 is a diagram showing an example of a lighting system 10 according to an embodiment. The lighting system 10 includes a plurality of lighting fixtures 12, a lighting control controller 30 communicably connected to the lighting fixtures 12, and a terminal device 40 that controls the plurality of lighting fixtures 12.

No particular limitation is imposed on the number of lighting fixtures 12 provided in the lighting system 10. Each of the plurality of lighting fixtures 12 is, for example, a ceiling light. The lighting fixture 12 may be another type such as a downlight or a spotlight.

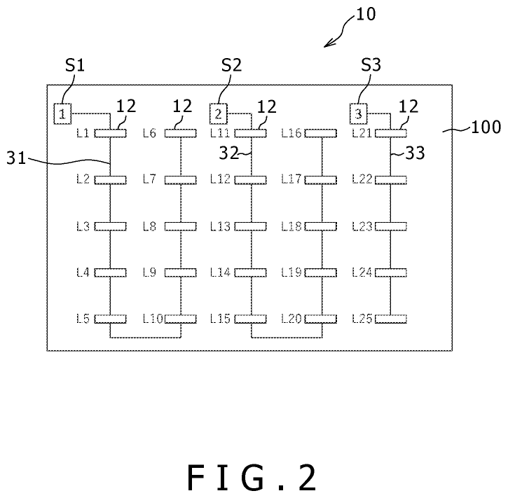

FIG. 2 is a view showing arrangement positions and wire-connection states of the plurality of lighting fixtures 12 in a room 100 in the lighting system 10. As shown in FIG. 2, the plurality of lighting fixtures 12 are lined up and mounted on a ceiling of one room 100. In FIG. 2, the plurality of lighting fixtures 12 are substantially equally arranged in a transverse direction (a left-right direction in FIG. 2) in five rows, and five lighting fixtures 12 are substantially equally arranged in vertical direction (an up-down direction in FIG. 2) in each of the rows. Among the lighting fixtures 12 in five rows, the lighting fixtures 12 in first and second rows as one end portion in the transverse direction (a left end portion in FIG. 2) are connected to each other by a first electric wire 31. One end of the first electric wire 31 is connected to an external AC power supply 37 (FIG. 1) via a first switch S1 and a breaker 35 (FIG. 1). The lighting fixtures 12 in third and fourth rows as intermediate portions in the transverse direction are electrically connected in series to each other by a second electric wire 32. One end of the second electric wire 32 is connected to the external AC power supply 37 via a second switch S2 and the breaker 35. The lighting fixtures 12 in the fifth row as the other end portion in the transverse direction (a right end portion in FIG. 2) are connected to each other by a third electric wire 33. One end of the third electric wire 33 is connected to the external AC power supply 37 via a third switch S3 and the breaker 35. Thus, the lighting fixtures 12 in the first and second rows, the lighting fixtures 12 in the third and fourth rows, and the lighting fixtures 12 in the fifth row can be independently turned on and off using the corresponding switches S1, S2, and S3, respectively. Each of the lighting fixtures 12 is communicably connected to the lighting control controller 30 by wireless. The lighting control controller 30 is communicably connected to the terminal device 40 by wireless. The first switch S1, the second switch S2, and the third switch S3 may be collectively referred to as a switch.

In FIG. 2, L1, L2, . . . , and L25 indicate identification information (ID) possessed by each of the lighting fixtures 12. The identification information may be any information so long as it can identify each of the lighting fixtures 12 with respect to the other lighting fixtures 12. For example, the identification information is a MAC address (Media Access Control address), barcode information, an RF (radio frequency) tag, product number information, an IP address, or a serial number of a product.

The lighting control controller 30 is arranged in the same room as the plurality of lighting fixtures 12. The lighting control controller 30 acquires association information, which is mapping information of the lighting fixtures 12, between the identification information and position information of the lighting fixtures 12, from the terminal device 40, and performs lighting control of the lighting fixtures 12 after completion of pairing with the lighting fixtures 12. The lighting control controller 30 can be a remote controller having an operation unit that allows a user to operate the lighting. The lighting control controller 30 wirelessly controls the lighting fixture 12 from the lighting control controller 30 by a control signal from the terminal device 40 and a schedule function stored therein.

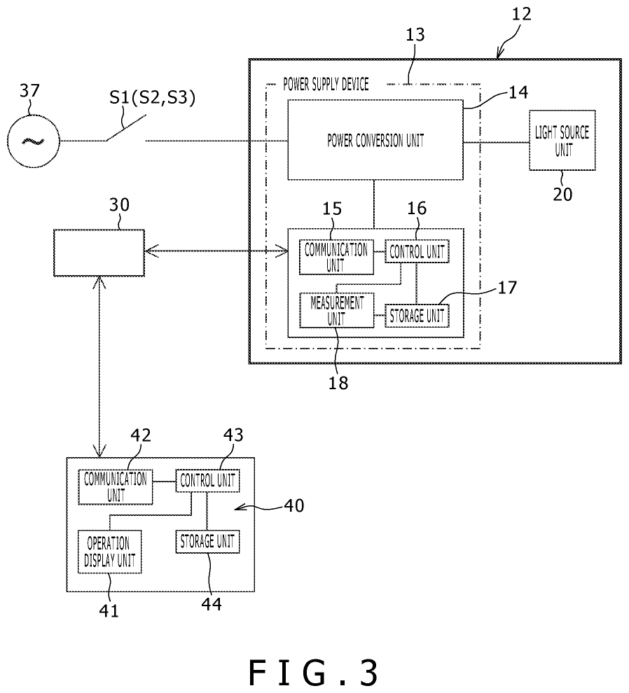

FIG. 3 is a block diagram showing configurations of each of the lighting fixtures 12 and the terminal device 40. Each of the plurality of lighting fixtures 12 includes a power supply device 13 and a light source unit 20. The power supply device 13 includes a power conversion unit 14, a communication unit 15, a control unit 16, a storage unit 17, and a measurement unit 18, and is incorporated in the lighting fixture 12. The power conversion unit 14 converts AC power supplied from the external AC power supply 37 into DC power, adjusts a voltage based on a control signal due to the control unit 16 to be described below, and outputs the voltage to the light source unit 20 to be described below.

The communication unit 15 is an interface used for the lighting fixture 12 to wireless communicate with the lighting control controller 30. The communication unit 15 includes a wireless transceiver.

The control unit 16 controls the communication unit 15 and the power conversion unit 14. The control unit 16 transmits information stored in the storage unit 17, which will be described below, to the terminal device 40 via the communication unit 15 and the lighting control controller 30 according to an operation signal received from the terminal device 40 via the lighting control controller 30 and the communication unit 15. The control unit 16 includes, for example, a CPU, and arithmetic processing is executed by a program stored in the storage unit 17. Further, the control unit 16 causes the communication unit 15 to transmit to the terminal device 40 the identification information and information measured and acquired by the measurement unit 18 as described below.

The storage unit 17 is realized by a ROM such as an EEPROM, a RAM, an HDD, or a flash memory, for example. The storage unit 17 has a function of storing the received operation signal and information acquired by the measurement unit 18 to be described below.

The measurement unit 18 measures information based on a predetermined operation or a predetermined action. When a predetermined detection is made, the measurement unit 18 stores the information measured by the measurement unit 18 in the storage unit 17. The “predetermined operation” is, for example, an on or off operation of a switch. The “information” is, for example, any one of an energizing time, a non-energizing time, the number of times of zero crossing of the input voltage, and the number of on/off times of the power in the lighting fixture 12. As will be described in another example of the embodiment described below, the “information” may be a combination of any two or more of the energizing time, the non-energizing time, the number of times of zero crossing of the input voltage, and the number of on/off times of the power in the lighting fixture 12, or may be obtained by adding time-series information to such a combination. The “energizing time” is a time until the power is supplied to the power supply device 13 and the power is cut off. The “non-energizing time” is a power-off time when the power supply is quickly switched from off to on within a predetermined time (for example, within 2 seconds) in an energized state of the power supply device 13. Hereinafter, the switching from power-off to power-on may be described as an “off-on operation”. The “predetermined detection” is, for example, detection of power cutoff. For example, when the power cutoff is detected, the power supply device 13 stores the information measured by the measurement unit 18 in the storage unit 17. The number of number of on/off times of the power supply may be measured by a counter provided inside the measurement unit 18. The number of on/off times of the power supply may be the “number of power supply times” that the power is supplied to the power supply device 13 within a predetermined time, which is a short time, or may be the “number of power cutoff times” that the power is cut off in a short time. Further, the information may be information that is not be measured by the measurement unit 18, and the information such as the time and the number of times may be measured by the control unit 16. During an off-on operation of the lighting fixture 12 in a short time, the output of the power conversion unit 14 of the power supply device 13 is stopped and the light source unit 20 is turned off, but the power supply to the control unit 16 is maintained for a time of about 10 seconds, for example, and the control unit 16 actuates. An input voltage detection unit of the power supply device 13 is not shown.

An example of a predetermined action for the measurement unit 18 to start measuring the information includes the following action. First, as a power supply action, the input voltage of the power supply device 13 is detected by a circuit, and the control unit 16 is actuated by a control power supply at the time of power cutoff after about several seconds. For example, the above action is performed by performing the off-on operation of the power supply device 13 quickly (within about 2 seconds) in an energized state. Further, the above action may be performed by repeatedly performing the off-on operation of the power supply device 13 quickly (within about 2 seconds) three times in an energized state.

The storage unit 17 may be in an initial state in which there is no data in the storage unit 17 when the power is supplied. An example of the action for initializing the storage unit 17 may include a case where the communication unit 15 receives a specific signal or a case where the off-on operation of the power supply is repeated quickly (within about 2 seconds) five times.

In addition, when the communication unit 15 receives a specific signal as the predetermined action of the communication unit 15, the measurement unit 18 may start measuring information.

Further, as the predetermined action of the control unit 16, the above power supply action is performed to cut off the power supply once, and the control unit 16 starts to actuate as a measurement mode when the next power is supplied after a sufficient time (for example, about several tens of seconds) has passed, and may cause the measurement unit 18 to start measuring the information.

When the power supply device 13 performs a series of actions of the power supply and the power supply cutoff to the control unit 16 from outside one or more times by the predetermined operation, the storage unit 17 may store, as information, at least one of the energizing time, the non-energizing time, the number of times of zero crossing of the input voltage, and the number of on/off times of the power in the lighting fixture 12.

The light source unit 20 emits illumination light when electric power is supplied. For example, the light source unit 20 is an LED, a fluorescent lamp, or a halogen lamp.

The terminal device 40 and the lighting control controller 30 are communicably connected to each other, and the lighting control controller 30 and the lighting fixture 12 are communicably connected to each other, by specific low power wireless communication using a frequency in 920 MHz band or 2.4 GHz band, or wireless communication such as BLE (Bluetooth (registered trademark) Low Energy), Wi-Fi (registered trademark), or Bluetooth (registered trademark).

The terminal device 40 is, for example, a tablet PC or a smartphone having a function of transmitting and receiving signals and a display screen. The terminal device 40 is a setting device that performs mapping which is an association of the identification information of each of the lighting fixtures 12 with the position information of the lighting fixtures 12 within the room. The lighting fixture 12 is paired with the lighting control controller 30 by such mapping, and thus lighting control can be performed by the lighting control controller 30.

The terminal device 40 includes an operation display unit 41, a communication unit 42, a control unit 43, and a storage unit 44. The operation display unit 41 corresponds to a display unit. The operation display unit 41, for example, includes a touch panel screen which is a display screen. The operation display unit 41 has a function of an input unit that receives a user's operation and a function of displaying marks indicating installation positions of the plurality of lighting fixtures 12 and the identification information of the plurality of lighting fixtures 12. When the operation display unit 41 is operated so as to associate the identification information of the lighting fixtures 12 displayed on the terminal device 40 with the mark, the control unit 43 stores in the storage unit 44 the association between the identification information and the position information of the lighting fixture 12 represented by the mark. The terminal device may be configured to have the display unit and the operation unit separately.

The communication unit 42 is an interface for the terminal device 40 to wirelessly communicate with the lighting fixture 12 via the lighting control controller 30.

The control unit 43 has a function of controlling the communication unit 42 and a function of controlling a display state of the operation display unit 41. The control unit 43 includes, for example, a CPU, and arithmetic processing is executed by a program stored in the storage unit 44.

The storage unit 44 is realized by a ROM, a RAM, an HDD, or a flash memory, for example. The storage unit 44 stores an application program for actuating the control unit 43. By causing the control unit 43 to execute a mapping program as an application program, the user can cause the operation display unit 41 to display a screen for mapping the lighting fixture 12. The mapping program can be read by the terminal device 40, and is executed such that the terminal device 40 classifies the plurality of lighting fixtures 12 based on the information acquired by each of the plurality of lighting fixtures 12 and causes the operation display unit 41 to display them. When the mapping program is executed, the terminal device 40 displays an arrangement plan of the plurality of lighting fixtures 12 and the identification information of the plurality of lighting fixtures 12 on the operation display unit 41.

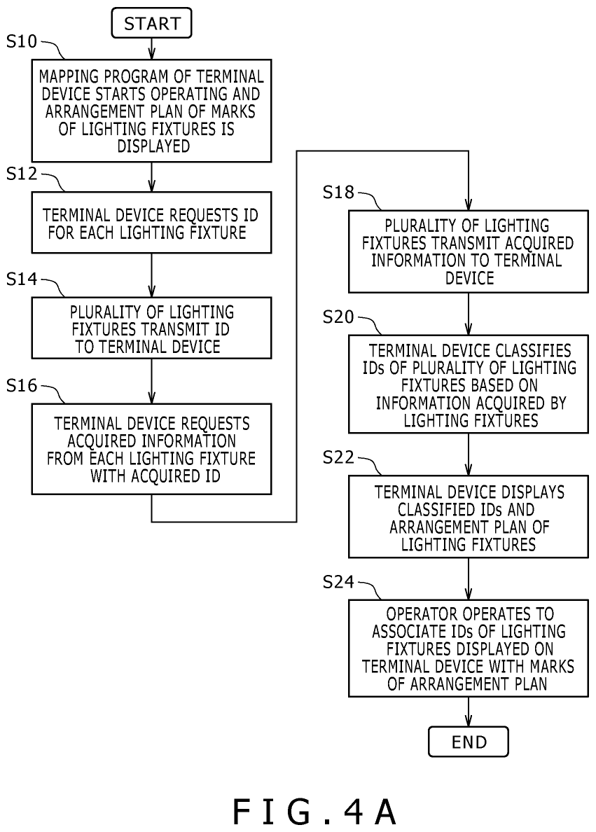

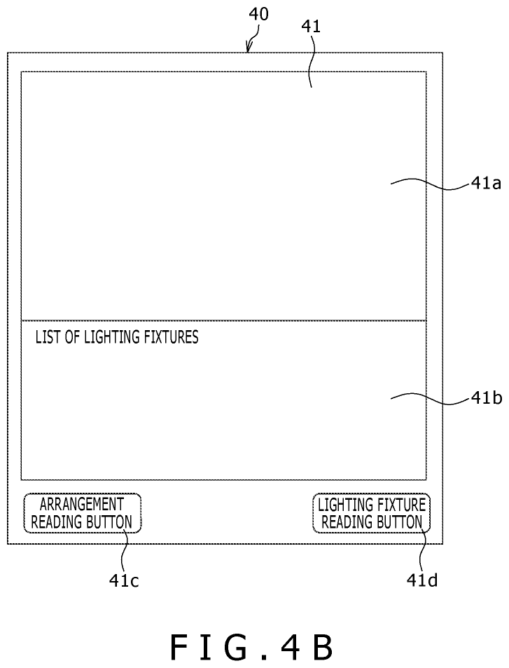

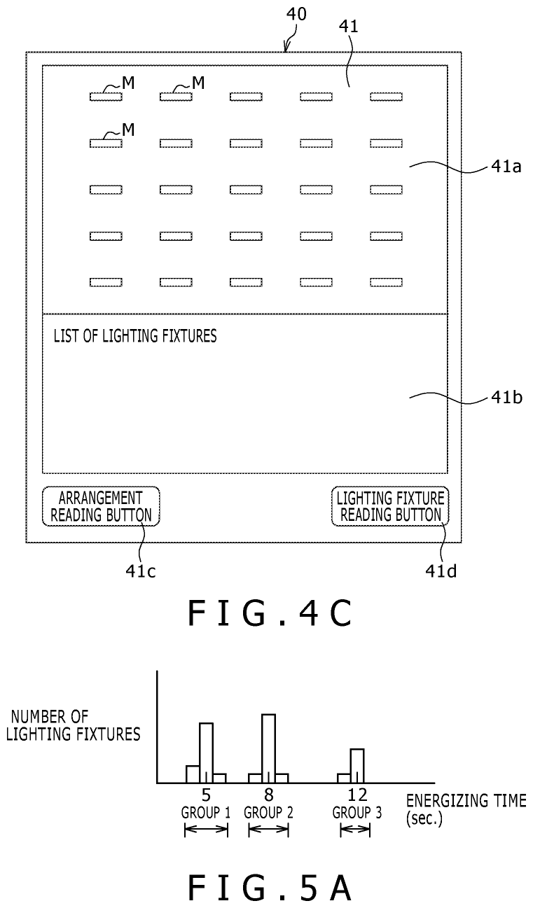

Next, a mapping method of the lighting system 10 will be described. FIG. 4A is a flowchart showing the mapping method of the lighting system 10. First, in step S10, the mapping program starts operating in the terminal device 40 by a mapping operator corresponding to the user. FIG. 4B shows a screen immediately after the start of operation of the mapping program in the operation display unit 41 of the terminal device 40. On this screen, a first display scheduled portion 41a of the arrangement plan of the lighting fixtures 12 and a second display scheduled portion 41b of the identification information of the lighting fixtures 12 are divided with respect to a vertical direction, and an arrangement plan reading button 41c and a lighting fixture reading button 41d are displayed at a lower part. Characters of “List of Lighting Fixtures” are displayed on the second display scheduled portion 41b. In step S10, when the arrangement plan reading button 41c is pressed down by the operator on this screen, the arrangement plan of the plurality of lighting fixtures 12 is displayed on the first display scheduled portion 41a.

FIG. 4C shows a screen displayed by pressing the arrangement plan reading button 41c in FIG. 4B. At this time, the terminal device 40 reads the arrangement plan of the lighting fixtures 12 in the room or area to be set, which is created in advance, and the arrangement plan is displayed on the first display scheduled portion 41a. In the arrangement plan of FIG. 4C, each lighting fixture 12 is indicated by a mark M. In FIG. 4C, the mark M has a rectangular shape, but it may have another shape such as a circle. The arrangement plan corresponds to a view when the plurality of lighting fixtures 12 installed in an interior is viewed from above. The mark M may be a symbol, a character, or a pictogram. In the example shown in FIG. 4C, the marks M of the lighting fixtures 12 are arranged in five rows in both the vertical direction and the transverse direction as shown in FIG. 2. Then, in step S12 of FIG. 4A, the terminal device 40 transmits a signal requesting the identification information (ID) of the lighting fixtures 12 to the lighting control controller 30, and the lighting control controller 30 transmits a signal to request the transmission of the identification information to all the lighting fixtures 12. Specifically, when the operator pushes down the lighting fixture reading button 41d on the screen of FIG. 4C, steps S12 to S22 of FIG. 4A actuate.

Thereby, in step S14, the plurality of lighting fixtures 12 transmit the identification information to the lighting control controller 30, and the lighting control controller 30 transmits the identification information to the terminal device 40. In step S16, the terminal device 40 transmits the signal requesting the stored information to the lighting control controller 30 for the acquired identification information of the plurality of lighting fixtures 12. The lighting control controller 30 transmits the signal to request the transmission of the information to the plurality of lighting fixtures 12 having the corresponding identification information.

Thus, in step S18, the plurality of lighting fixtures 12 transmit the acquired information to the lighting control controller 30, and the lighting control controller 30 transmits such information to the terminal device 40. At this time, the respective switches S1, S2, and S3 shown in FIG. 1 are turned on in advance by a mapping operator corresponding to the user, and then are turned off after arbitrary times (energizing times) different from each other between the switches S1, S2, and S3. The turning on and off of the switches S1, S2, and S3 corresponds to the predetermined operation.

Table 1 indicates an example of the energizing times of the switches S1, S2, and S3, and the energizing times of the switches S1, S2, and S3 are different from each other.

TABLE 1

| | Energizing |
|---|---|
| Switch | Time (sec.) |
| S1 | 5 |
| S2 | 8 |
| S3 | 12 |

Table 2 indicates an example of a relation between the identification information (ID) and the energizing time of each of the lighting fixtures 12.

TABLE 2

| | Energizing |
|---|---|
| ID | Time (sec.) |
| L1 | 4.95 |
| L2 | 5.01 |
| L3 | 5.1 |
| L4 | 4.99 |
| L5 | 5.05 |
| . . . | . . . |
| L11 | 8.03 |
| L12 | 8.06 |
| . . . | . . . |
| L21 | 12.01 |
| L22 | 11.98 |
| . . . | . . . |
| L25 | 12.03 |

As indicated in Table 2, the energizing times of the switches S1, S2, and S3 may be slightly different from the energizing times of the plurality of lighting fixtures 12 connected to the same switches S1, S2, and S3. The reason is because, for example, a timing of current input and current cutoff may vary between the plurality of lighting fixtures 12 connected to the same switches, due to the influence of capacitors inside the lighting fixtures 12.

Based on the predetermined operation described above, each of the lighting fixtures 12 measures, for example, the energizing time as information with the measurement unit 18, and stores the energizing time measured by the measurement unit 18 in the storage unit 17 when the predetermined detection described above is performed. Each of the lighting fixtures 12 transmits the acquired energizing time to the terminal device 40.

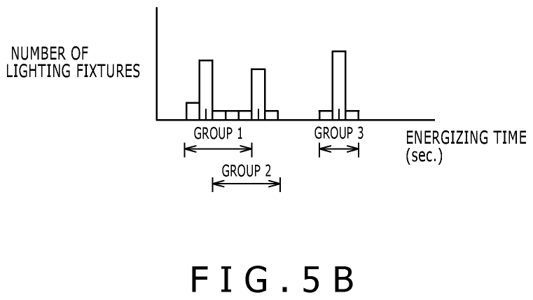

Returning to FIG. 4A, in step S20, the terminal device 40 executes the application program to classify the identification information of the plurality of lighting fixtures 12 based on the information acquired by the lighting fixture 12. FIG. 5A shows an example of a relation between the energizing time and the number of the lighting fixtures 12 acquired when the energizing times of the plurality of switches S1, S2, and S3 are made different in the embodiment. In the example shown in FIG. 5A, the distribution of the number of elements (the number of lighting fixtures) of a plurality of groups 1 to 3 of the lighting fixtures 12 corresponding to the plurality of switches S1, S2, and S3 is divided without intersecting.

On the other hand, FIG. 5B shows another example of a relation between the energizing time and the number of the lighting fixtures 12 acquired when the energizing times of the plurality of switches S1, S2, and S3 are made different in the embodiment. As shown in FIG. 5B, it is conceivable that the distribution of the number of elements of a plurality of groups 1 to 3 of the lighting fixtures 12 corresponding to the plurality of switches S1, S2, and S3 intersect partially. In the following, first, the case of FIG. 5A will be described.

As shown in FIG. 5A, the terminal device 40 classifies the lighting fixtures 12 into a plurality of groups, groups 1 to 3, according to the energizing time. At this time, the terminal device 40 executes the application program to associate the acquired identification information of the lighting fixture 12 with the energizing time as the information acquired from the lighting fixture 12. Further, the terminal device 40 sorts the acquired energizing times in ascending order to line up the acquired energizing times from the minimum value to the maximum value, increases the group number, which is the number of sections, from 1, and calculates the number of elements for each group. As shown in FIG. 5A, when there is a distribution of the energizing time and the elements are separated by the energizing time when the number of elements becomes 0, the lighting fixtures 12 are divided and grouped by the separated energizing time. When the elements are not separated, the lighting fixtures 12 are set to one group.

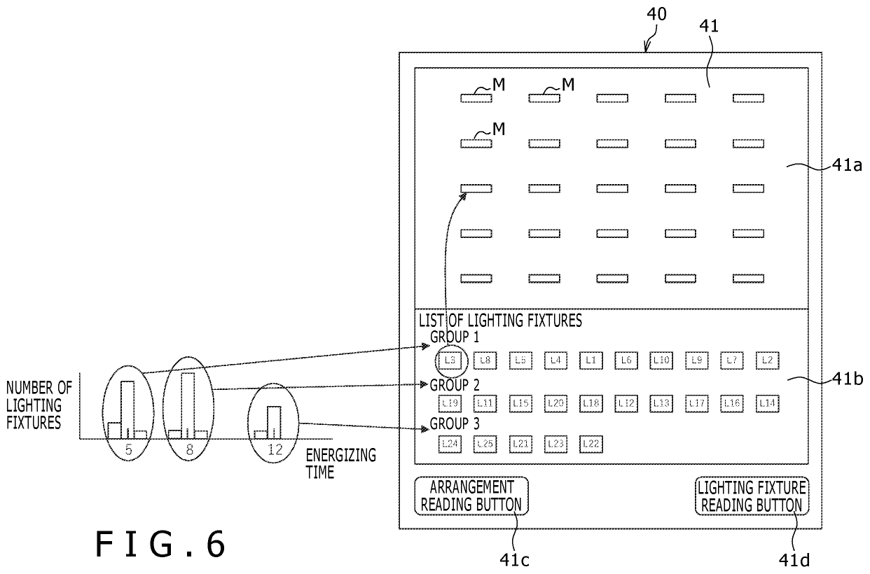

Next, as shown in step S22 of FIG. 4A, the terminal device 40 displays on the operation display unit 41 the classified identification information and the arrangement plan of the lighting fixtures 12 representing the position information of the lighting fixtures 12. FIG. 6 shows identification information L1 to L25 of the grouped lighting fixtures 12 on the screen displayed by pressing the lighting fixture reading button 41d in FIG. 4C and the relation between the energizing time and the number of lighting fixtures 12.

In FIG. 6, the screen of the operation display unit 41 of the terminal device 40 is shown on a right side, and the relation between the energizing time and the number of lighting fixtures 12 similar to that in FIG. 5A is shown on a left side. In response to pressing of the lighting fixture reading button 41d, the classified identification information L1 to L25 of the lighting fixtures 12 are displayed in the second display scheduled portion 41b on the screen of FIG. 6. The identification information L1 to L25 are displayed by groups 1 to 3 divided into a predetermined direction (up-down direction in FIG. 6) and given by a group number, group 1 being a group in which the energizing time is minimum, group 3 being a group in which the energizing time is maximum, group 2 being a group in which the energizing time is intermediate. In the second display scheduled portion 41b, the identification information may be displayed side by side in the order of addresses for each of the groups 1 to 3.

Then, as shown in step S24 of FIG. 4A, the operator operates the terminal device 40 to associate the identification information L1 to L25 of the lighting fixtures 12 displayed on the terminal device 40 with the marks M in the arrangement plan of the plurality of lighting fixtures 12. For example, the operator selects one of a plurality items of identification information. For example, as shown in FIG. 6, the operator selects the identification information L3 of the group 1 by touching it with a finger. Thus, a blinking command signal from the terminal device 40 is transmitted to the lighting fixture 12 corresponding to the identification information L3 selected via the lighting control controller 30, and the lighting fixture 12 blinks. By visually confirming the position of the blinking lighting fixture 12, the operator recognizes a certain mark M out of the plurality of Marks M at which the lighting fixture 12 corresponding to the identification information L3 is located, and specifies an actual position of such a lighting fixture 12. Next, the operator selects the mark M at the position corresponding to the blinking lighting fixture 12 by touching it with a finger. At this time, the operator may be able to select the mark M in such a manner of tapping the identification information L3 and dropping the identification information L3 by moving it to the mark M corresponding to the blinking lighting fixture 12 in a dragged state. Thereby, there is performed mapping that is an association between the identification information and the position information of the lighting fixture 12. Whenever the selection of the mark M in the terminal device 40 is completed, a lights-out command signal is transmitted from the terminal device 40 to the lighting fixture 12 corresponding to the mark M, and the blinking of the lighting fixture 12 is terminated. In the terminal device 40, the identification information of the lighting fixture 12 for which the association between the identification information and the position information of the lighting fixture 12 is completed is deleted from the display in the list of lighting fixtures in the second display scheduled portion 41b on the screen of the operation display unit 41.

Further, according to the operation of the association of the terminal device 40 by the user, the association between the identification information and the position information of the lighting fixture 12 is stored in the storage unit 44, and the information of the association is transmitted to the lighting control controller 30 at the same time. Such mapping work is performed on all the identification information displayed on the operation display unit 41. The lighting control controller 30 can control the lighting of the plurality of lighting fixtures 12 after the mapping work for all the identification information is completed and the pairing with the lighting fixture 12 is completed. It may be possible to perform setting such that the lighting, the lights-out, and dimming of each of the lighting fixtures 12 can be individually controlled by the selection operation of the lighting fixtures 12 by the terminal device 40.

In the above description, the case of classifying the identification information has been described when the distribution of the plurality of groups of the lighting fixtures 12 corresponding to the plurality of switches S1, S2, and S3 is divided without intersecting as in the example shown in FIG. 5A. On the other hand, some of the lighting fixtures 12 may be duplicated in groups and divided into a plurality of groups when the distribution of the plurality of groups of the lighting fixtures 12 corresponding to the plurality of switches S1, S2, and S3 partially intersect as in the example shown in FIG. 5B. At this time, in step S24 of FIG. 4A, when the identification information and the mark of the lighting fixture 12 are associated in one group among the plurality of groups to which the duplicated lighting fixture 12 belongs, the terminal device 40 may be configured to delete the identification information of the duplicated lighting fixture 12 from the display of another group. Thereby, after the association of the duplicated lighting fixture 12 is performed once, the association is not requested again. Further, the number of switches connected to each group of the plurality of lighting fixtures 12 can be input to the terminal device 40, and the terminal device 40 may divide the distribution of the groups into the number of groups according to the input number for grouping. When the lighting fixture 12 has not acquired the information, the terminal device 40 displays the information in one group.

According to the lighting system 10, the power supply device 13, the mapping method, and the program described above, it is possible to shorten the work time when the plurality of lighting fixtures 12 are mapped using the terminal device 40. Specifically, the terminal device 40 displays, based on the information from the lighting fixture 12, the identification information of the plurality of lighting fixtures 12 connected to the same switch as one group. At this time, it is highly possible that the plurality of lighting fixtures 12 connected to the same switch are arranged close to each other. Thereby, the identification information of the same group corresponds to the plurality of lighting fixtures 12 in close positions. For this reason, when the terminal device 40 selects the identification information of the same group, the plurality of lighting fixtures 12 whose actual positions are close to each other are blinked to specify the position, so that the work time of the mapping can be shortened. For example, since the lighting fixtures 12 of the group 1 are connected by the same first switch as the identification information L3, when the operator performs the association of the mark of another lighting fixture 12 of the group 1 after performing the association of the identification information L3, the operator may confirm the lighting fixture 12 blinking near the lighting fixture 12 having the identification information L3. This makes it possible to perform the mapping work efficiently.

Further, when the lighting system 10 is installed in a commercial facility or the like such as a shopping mall having an open ceiling, it is conceivable that the terminal device 40 acquires the identification information from the lighting fixtures 12 installed on different floors when the identification information from the lighting fixtures 12 are acquired from the terminal device 40 using a wireless signal.

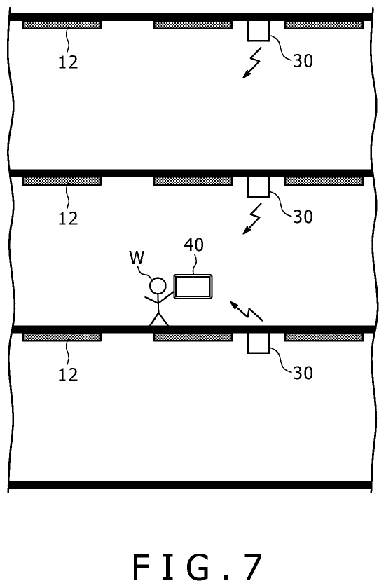

FIG. 7 is a schematic view showing a state in which the terminal device 40 receives information via the lighting control controller 30 from a plurality of lighting fixtures 12 divided on different floors in the embodiment. As in the example of FIG. 7, there is a case where the terminal device 40 acquires identification information from the lighting fixture 12 on a floor different from the floor on which an operator W is located, via a lighting control controller 30 installed on such a floor. In this case, the terminal device 40 also displays identification information that is unnecessary at the present time.

In the case of this example, since the terminal device 40 can group the close lighting fixtures 12 connected to the same switch on the same floor to display the lighting fixtures 12 even in this case, based on the information acquired from the lighting fixtures 12, it is possible to shorten the work time of mapping without taking time to confirm whether the lighting fixtures 12 on the present floor require mapping.

In this example, when the terminal device 40 selects the identification information of the lighting fixture 12, the lighting fixture 12 is blinked, but the present invention is not limited thereto, and the lighting fixture 12 may be darkened or brightened to cause a change in dimming, and may be distinguished from another lighting fixture 12.

Further, as the information to be measured by the measurement unit 18, the case has been described where the identification information of the lighting fixtures 12 is classified by the energizing time, but the identification information of the lighting fixtures 12 may be classified using, as the information, any one of the non-energizing time of the lighting fixture 12, the number of times of zero crossing of the input voltage, and the number of on/off times of the power supply.

Further, the case has been described above where the terminal device 40 communicates with the plurality of lighting fixtures 12 via the lighting control controller 30, but the terminal device 40 may be configured to communicate directly with the plurality of lighting fixtures 12 by a wireless signal without the lighting control controller 30.

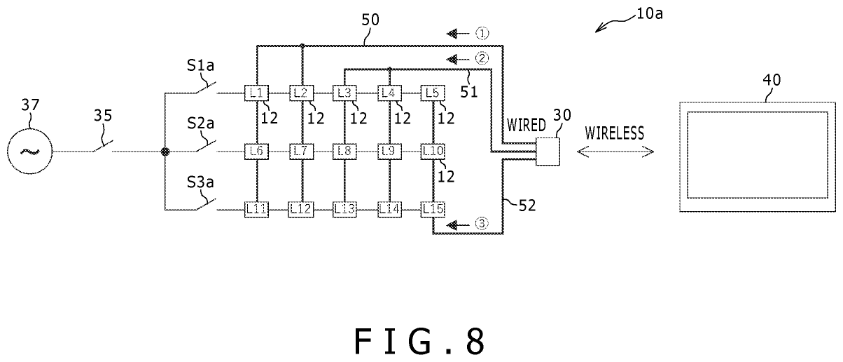

FIG. 8 is a diagram showing a lighting system 10a of another example of the embodiment. In the case of this example, unlike the configurations of FIGS. 1 to 6, the lighting control controller 30 is connected to a plurality of lighting fixtures 12 by a first control line 50, a second control line 51, and a third control line 52 which are wired lines. Identification information of the lighting fixture 12 is shown inside a rectangle showing the lighting fixture 12. Identification information L1, L2, L6, L7, L11, and L12 are connected by the first control line 50. Identification information L3, L4, L8, L9, L13, and L14 are connected by the second control line 51. Identification information L5, L10, and L15 are connected by the third control line 52.

By execution of a mapping program of the terminal device 40, a command signal for causing the lighting fixture 12 to store information is transmitted to the plurality of lighting fixtures 12 via the lighting control controller 30. Thus, the plurality of lighting fixtures 12 store the information in the storage unit 17 (FIG. 3). Specifically, the same data item, for example, data representing the same random 16-bit value, is transmitted to the plurality of lighting fixtures 12 connected to the same control lines 50 to 52 from the lighting control controller 30. Different data items are transmitted from the lighting control controller 30 to the plurality of lighting fixtures 12 connected to the different control lines 50 to 52. Each of the lighting fixtures 12 stores the transmitted data as information in the storage unit 17. The terminal device 40 executes the mapping program to transmit a signal requesting data as acquired information to each of the plurality of lighting fixtures 12 via the lighting control controller 30. In response to this, each of the lighting fixtures 12 transmits the data stored in the storage unit 17 to the terminal device 40 via the lighting control controller 30.

For example, as indicated in Table 3, a case is considered where different data items are transmitted from the lighting control controller 30 to the plurality of lighting fixtures 12 through the first to third control lines 50 to 52. Each data item indicated in Table 3 represents a hexadecimal number. In each data item, X indicates an arbitrary value.

TABLE 3

| Control Line | Data |
|---|---|
| First Control Line (1) | XX01 |
| Second Control Line(2) | XX02 |
| Third Control Line(3) | XX03 |

At this time, as indicated in Table 4, Corresponding data are transmitted to the lighting fixtures 12 having identification information, respectively.

TABLE 4

| ID | Data |
|---|---|
| L1, L2, L6, L7, L11, L12 | XX01 |
| L3, L4, L8, L9, L13, L14 | XX02 |
| L5, L10, L15 | XX03 |

In this case, when the communication unit 15 (FIG. 3) receives from the lighting control controller 30 a signal including data as a specific signal, the power supply device 13 (FIG. 3) of each of the lighting fixtures 12 stores such data in the storage unit 17. When the terminal device 40 transmits a command signal requesting the acquired information to the lighting fixture 12, the lighting fixture 12 transmits the data stored in the storage unit 17, as the acquired information, to the terminal device 40. The terminal device 40 classifies the identification information of the plurality of lighting fixtures 12 into the same group of the lighting fixtures 12 having the same data item, and displays the identification information in a group on the operation display unit 41 (FIG. 6).

According to the configuration of this example, it is highly possible that the lighting fixtures 12 connected by the same control lines 50 to 52 are installed nearby, in terms of cost and the like. Thereby, when the identification information of the same group is selected in the terminal device 40, the plurality of lighting fixtures 12 whose actual positions are close to each other are blinked to specify the position, so that the work time of the mapping can be shortened. In this example, other configurations and operations are the same as those of FIGS. 1 to 6.

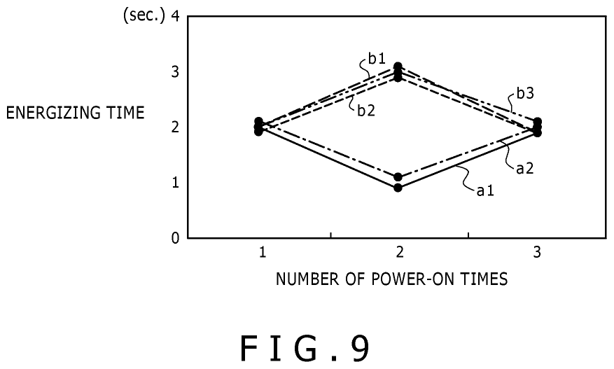

FIG. 9 is a diagram showing an example of a relation between the number of power-on times of some of the lighting fixtures 12 and the energizing time corresponding to the number of power-on times which are acquired in a lighting system of another example of the embodiment. A basic configuration of the lighting system of this example is the same as the configuration of FIGS. 1 to 6. In the case of this example, the power supply device 13 in each of the lighting fixtures 12 measures the energizing time for each power-on and the number of off-on operation times when the off-on operation is performed in a short time; that is, when the power is turned on from the power-off operation, using the measurement unit 18 (FIG. 3), and stores the energizing time and the number of off-on operation times in the storage unit 17 (FIG. 3). This will be described below in the case where the lighting fixtures 12 are arranged in the same manner as in FIG. 6. First, the terminal device 40 transmits to the lighting fixture 12 a command signal requesting the acquired information, and when the transmission is made, the lighting fixture 12 transmits to the terminal device 40 the energizing time and the number of off-on operation times (number of off-on times), which are stored as the acquired information in the storage unit 17. For example, the operator operates the switches S1 to S3 as indicated in Table 5, and the lighting fixtures 12 connected to each of the switches S1 to S3 store the number of off-on times and the energizing time in the storage unit 17. For example, by the operation of the switch S1, the number of off-on times is set to 1, the energizing time of the switch S1 is set to 2 seconds at the time of first power-on, and the next energizing time is set to 3 seconds.

TABLE 5

| | Number of Off- | Energizing |
|---|---|---|
| Switch | On Times | Time (sec.) |
| S1 | 1 | 2, 3 |
| S2 | 2 | 2, 1, 2 |
| S3 | 2 | 2, 3, 2 |

At this time, the relation between the number of off-on times and the energizing time of each of the lighting fixtures 12 is indicated in Table 6.

TABLE 6

| | Energizing | Number of Off- |
|---|---|---|
| ID | Time (sec.) | On Times |
| L1 | 2.1, 3.0 | 1 |
| L2 | 2.0, 3.0 | 1 |
| L3 | 1.9, 2.9 | 1 |
| L4 | 2.0, 3.1 | 1 |
| L5 | 1.9, 2.9 | 1 |
| . . . | . . . | . . . |
| L11 | 2.0, 0.9, 1.9 | 2 |
| L12 | 2.1, 1.1, 2.0 | 2 |
| . . . | . . . | . . . |
| L21 | 2.0, 3.1, 1.9 | 2 |
| L22 | 1.9, 2.9, 1.9 | 2 |
| . . . | . . . | . . . |
| L25 | 2.0, 3.0, 2.1 | 2 |

Then, the terminal device 40 acquires the energizing time and the number of off-on times from each of the plurality of lighting fixtures 12, and first classifies the identification information of the lighting fixtures 12 with the number of off-on times. Next, with the same number of off-on times, the acquired energizing times are sorted in ascending order to be lined up from the minimum value to the maximum value, the group number, which is the number of sections, is increased from 1, and the number of elements for each group is calculated. At this time, when there is a distribution of the information and the elements are separated by the information when the number of elements becomes 0, the lighting fixtures 12 are divided and grouped by the separated information. When the elements are not separated, the lighting fixtures 12 are set to one group. In the distribution of the information, when distributions having a plurality of peaks are duplicated, some of the lighting fixtures 12 are duplicated in a plurality of groups and are grouped. When the association between the identification information and the position information of the duplicated lighting fixtures 12 is completed, the duplicated lighting fixtures 12 are deleted from the display of the other group.

For example, in the case of Table 6, the number of off-on times is 1 for identification information L1 to L10, and the number of off-on times is 2 for identification information L11 to L25. At this time, in the lighting fixtures 12 of the identification information L1 to L10 connected to the first switch S1, the number of off-on times is 1, and the distribution of the energizing time can be treated as the same group, which is set to a group 1.

In the lighting fixtures 12 of the identification information L11 to L25 connected to the second switch S2 and the third switch S3, the number of off-on times is two, which is the same, and there is only one peak in the distribution of each of the first and third energizing times during the power-on. On the other hand, in the lighting fixtures 12 of the identification information L11 to L25, there are two peaks, including a peak before and after 1 second and a peak before and after 2 seconds, in the distribution of the second energizing time during the power-on. For this reason, the lighting fixtures 12 having the second energizing time of about 1 second are referred to as group 2, and the lighting fixtures 12 having the second energizing time of about 3 seconds are referred to as group 3. FIG. 9 shows the relation between the number of power-on times and the energizing time for the lighting fixtures 12 of the identification information L11, L12, L21, L22, and L25. A solid line a1 and an alternate long and short dash line a2 correspond to the identification information L11 and L12, respectively, and a long dashed line b1, a short dashed line b2, and an alternate long and two short dashes line b3 correspond to the identification information L21, L22, and L25, respectively. In FIG. 9, it can be confirmed that there are two peaks in the distribution of the second energizing time. Thereby, the terminal device 40 can classify the plurality of lighting fixtures 12 based on the information acquired from the lighting fixtures 12.

In the configuration of this example as described above, the terminal device 40 acquires information obtained by adding time-series information to a combination of the energizing time and the number of power-on times of the lighting fixtures 12, and classifies the plurality of lighting fixtures 12 based on such information. Thereby, the types of information acquired by the terminal device 40 are increased, whereby the accuracy of grouping the lighting fixtures 12 can be improved, and accordingly, the work time of the mapping can be shortened. In this example, other configurations and operations are the same as those of FIGS. 1 to 6.

In the above configuration, the case has been described where the measurement unit 18 measures the “information” obtained by adding the time-series information to the combination of the energizing time and the number of power-on times of the lighting fixtures 12, but the present invention is not limited thereto, and the above “information” may be information obtained by adding the time-series information to the combination of two or more of the energizing time, the non-energizing time, the number of times of zero crossing of the input voltage, and the number of on/off times of the power in the lighting fixture 12.

Next, the lighting system of another example of the embodiment will be described. A basic configuration of the lighting system of this example is the same as the configuration of FIGS. 1 to 6.

In the case of this example, the power supply device 13 of each of the lighting fixtures 12 measures the energizing time for each power-on, the number of off-on times, and a cumulation of the energizing times (cumulative energizing time); that is, a total energizing time when the off-on operation is performed in a short time; that is, when the power is turned on from the power-off operation, using the measurement unit 18 (FIG. 3), and stores them in the storage unit 17 (FIG. 3). This will be described below in the case where the lighting fixtures 12 are arranged in the same manner as in FIG. 6. First, the terminal device 40 transmits to the lighting fixture 12 a command signal requesting the acquired information, and when the transmission is performed, the lighting fixture 12 transmits to the terminal device 40 the energizing time, the number of off-on times, and the cumulative energizing time, which are stored as the acquired information in the storage unit 17. For example, the operator operates the switches, and the lighting fixtures 12 connected to each of the switches store the energizing time for each power-on, the number of off-on times, and the cumulative energizing time. Table 7 indicates an example of a relation between the energizing time for each power-on, the number of off-on times, and the cumulative energizing time of each of the lighting fixtures 12.

TABLE 7

| | | | Cumulative |
|---|---|---|---|
| | Energizing | Number of Off- | Energizing |
| ID | Time (sec.) | On Times | Time (sec.) |
| L1 | 2.1, 3.0 | 1 | 5.1 |
| L2 | 2.0, 3.0 | 1 | 5.0 |
| L3 | 1.9, 2.9 | 1 | 4.8 |
| L4 | 2.0, 3.1 | 1 | 5.1 |
| L5 | 1.9, 2.9 | 1 | 4.8 |
| . . . | . . . | . . . | . . . |
| L11 | 2.0, 0.9, 1.9 | 2 | 4.8 |
| L12 | 2.1, 1.1, 2.0 | 2 | 5.2 |
| . . . | . . . | . . . | . . . |
| L21 | 2.0, 3.1, 1.9 | 2 | 7.0 |
| L22 | 1.9, 2.9, 1.9 | 2 | 6.7 |
| . . . | . . . | . . . | . . . |
| L25 | 2.0, 3.0, 2.1 | 2 | 7.1 |

Then, the terminal device 40 acquires the energizing time, the number of off-on times, and the cumulative energizing time from each of the plurality of lighting fixtures 12, and first classifies the identification information of the lighting fixtures 12 with the number of off-on times. Next, with the same number of off-on times, the acquired energizing times are sorted in ascending order to be lined up from the minimum value to the maximum value, the group number, which is the number of sections, is increased from 1, and the number of elements for each group is calculated. At this time, when there is a distribution of the information and the elements are separated by the information when the number of elements becomes 0, the lighting fixtures 12 are divided and grouped by the separated information. When the elements are not separated, the lighting fixtures 12 are set to one group.

For example, in the case of Table 7, the number of off-on times is 1 for identification information L1 to L10, and the number of off-on times is 2 for identification information L11 to L25. At this time, in the lighting fixtures 12 of the identification information L1 to L10 connected to the first switch S1, the number of off-on times is 1, and the distribution of the energizing time can be treated as the same group, which is set to a group 1.

In the lighting fixtures 12 of the identification information L11 to L25 connected to the second switch S2 and the third switch S3, the number of off-on times is two, which is the same. On the other hand, in the lighting fixtures 12 of the identification information L11 to L25, there are two peaks, including a peak before and after 5 seconds and a peak before and after 7 seconds, in the distribution of the cumulative energizing time. For this reason, the lighting fixtures 12 having the cumulative energizing time of about 5 seconds are referred to as group 2, and the lighting fixtures 12 having the cumulative energizing time of about 7 seconds are referred to as group 3. Thereby, the terminal device 40 can classify the plurality of lighting fixtures 12 based on the information acquired from the lighting fixtures 12.

In the configuration of this example as described above, the terminal device 40 acquires, as information, a combination of the energizing time, the number of power-on times, and the cumulative energizing time of the lighting fixtures 12, and classifies the plurality of lighting fixtures 12 based on such information. Thereby, the types of information acquired by the terminal device 40 are increased, whereby the accuracy of grouping the lighting fixtures 12 can be improved, and accordingly, the work time of the mapping can be shortened. In this example, although the accuracy of grouping may be lower than that of the configurations described with reference to FIG. 9, Table 5, and Table 6, the separation process in the terminal device 40 becomes easier. In this example, other configurations and operations are the same as those of FIGS. 1 to 6.

In the above configuration, the case has been described where the measurement unit 18 measures, as the “information”, the combination of the energizing time, the number of power-on times, and the cumulative energizing time of the lighting fixtures 12, but the present invention is not limited thereto, and the above “information” may be the combination of two or more of the energizing time, the non-energizing time, the number of times of zero crossing of the input voltage, and the number of on/off times of the power in the lighting fixture 12.

According to at least one of the above embodiments, the power supply device incorporated in the lighting fixture is disclosed. The power supply device includes a power conversion unit, a control unit, a communication unit, a storage unit, and a measurement unit, measures information in the measurement unit based on a predetermined operation or action, and stores the information measured by the measurement unit in the storage unit when a predetermined detection is made. According to the above power supply device, it is possible to shorten a work time when mapping of the lighting fixtures is performed using the terminal device.

Further, according to at least one of the above embodiments, there is also disclosed the power supply device in which when a series of actions of the power supply and the power supply cutoff to the control unit from outside is performed one or more times by the predetermined operation in the power supply device, the storage unit stores, as information, one or more of the energizing time, the non-energizing time, the number of times of zero crossing of the input voltage, and the number of on/off times of the power in the lighting fixture.

### REFERENCE SIGNS LIST

10 lighting system, 12 lighting fixture, 13 power supply device, 14 power conversion unit, 15 communication unit, 16 control unit, 17 storage unit, 18 measurement unit, 20 light source unit, 30 lighting control controller, 31 first electric wire, 32 second electric wire, 33 third electric wire, 40 terminal device, 41 operation display unit, 42 communication unit, 43 control unit, 44 storage unit, 50 first control line, 51 second control line, 52 third control line, 100 room.

1. A lighting system comprising:
a plurality of lighting fixtures; and
a terminal device that controls the plurality of lighting fixtures, wherein
each of the plurality of lighting fixtures transmits identification information and acquired information to the terminal device, and
the terminal device classifies the plurality of lighting fixtures based on the information acquired by each of the plurality of lighting fixtures.

2. The lighting system according to claim 1, wherein the terminal device includes a display unit that displays the identification information of the classified lighting fixtures in a grouped manner.

3. The lighting system according to claim 1, wherein
each of the plurality of lighting fixtures comprises a power supply device and a light source unit, and
the power supply device includes a power conversion unit, a control unit, a communication unit, a storage unit, and a measurement unit, and is configured to measure the information in the measurement unit based on a predetermined operation or a predetermined action and to store the information measured by the measurement unit in the storage unit when a predetermined detection is performed.

4. The lighting system according to claim 3, wherein in each of the plurality of lighting fixtures, the information measured by the measurement unit is any one or a combination of any two or more of an energizing time, a non-energizing time, a number of times of zero crossing of an input voltage, and a number of on/off times of a power supply in the lighting fixture, or is obtained by adding time-series information to the combination.

5. The lighting system according to claim 3, wherein the communication unit of the power device includes a wireless transceiver.

6. A power supply device incorporated in the lighting fixture of the lighting system according to claim 1,
the power supply device comprising a power conversion unit, a control unit, a communication unit, a storage unit, and a measurement unit,
the power supply device being configured to measure the information in the measurement unit based on a predetermined operation or a predetermined action and to store the information measured by the measurement unit in the storage unit when a predetermined detection is performed.

7. The power supply device according to claim 6, wherein a series of actions of a power supply and a power supply cutoff to the control unit from outside is performed one or more times by the predetermined operation, the storage unit stores, as the information, one or more of an energizing time, a non-energizing time, a number of times of zero crossing of an input voltage, and a number of on/off times of power in the lighting fixture.

8. A lighting fixture comprising the power supply device according to claim 6.

9. A mapping method of the lighting system according to claim 1 by which the identification information of each of the plurality of lighting fixtures is associated with position information of the plurality of lighting fixtures, wherein
each of the plurality of lighting fixtures transmits the identification information and the acquired information to the terminal device,
the terminal device classifies and displays the identification information of the plurality of lighting fixtures based on the information acquired by each of the plurality of lighting fixtures, and
a user operates the terminal device so as to associate the identification information of the lighting fixtures displayed on the terminal device with marks indicating installation positions of the lighting fixtures.

10. A program capable of being read in the terminal device in the lighting system claim 1, the program causing the terminal device to execute classification of the plurality of lighting fixtures based on the information acquired by each of the plurality of lighting fixtures.
